(19) United States
(12) Patent Application Publication
(10) Pub. No.: US 2003/0130902 A1
(43) Pub. Date: Jul. 10, 2003

(54) Short range wireless system

(76) Inventor: Taranjeet S. Athwal, Richmond (CA)

Correspondence Address: Fasken Martineau DuMoulin LLP, Toronto-Dominion Centre, Suite 4200, Toronto Dominion Bank Tower, Box 20, Toronto, ON, M5K 1N6, CA

(21) Appl. No.: 10/286,948

(22) Filed: Nov. 4, 2002

(30) Foreign Application Priority Data
Nov. 2, 2001 (CA) 2,361,258

(51) Int. Cl. G06F 17/60

(52) U.S. Cl. 705/26

(57) ABSTRACT

An electronic commerce system including an electronic retail system for providing goods or services to a customer; and, a wireless communication device operable via a communications network, the device for initiating an electronic transaction with the electronic retail system, and for completing the transaction via the communications network.

This application claims priority from Canadian Patent Application No. 2,361,258, filed Nov. 2, 2001, and incorporated herein by reference.

The invention relates to the field of electronic commerce, and more specifically to electronic commerce transactions conducted with short-range mobile communications systems including mobile or cellular telephones.

### BACKGROUND OF THE INVENTION

Short-range wireless communication and personal area networks are proliferating in common household products as well as mobile business products. As described in U.S. Pat. No. 6,275,500, which is incorporated herein by reference, Bluetooth technology, for example, allows for the replacement of the many proprietary cables that connect one device to another with one universal short-range radio link. Bluetooth technology may replace the cumbersome cables used today to connect a laptop to a cellular telephone or between other devices such as printers, PDA's, desktops, fax machines, keyboards, joysticks or virtually any other digital device. Refrigerators, microwave ovens, dish washers, laundry washers and dryers, stereo, television, digital video disks, video games, lighting, irrigation, cooling and heating systems among others may also take advantage of such short-range radio links. Bluetooth radio technology further provides a universal bridge to existing data networks, a peripheral interface, and a mechanism to form small private ad hoc groupings of connected devices away from fixed network infrastructures. Designed to operate in a noisy radio frequency environment, Bluetooth radios use a frequency hopping scheme to make the link robust. Bluetooth radio modules avoid interference from other signals by hopping to a new frequency after transmitting or receiving a data packet.

While technologies such as Bluetooth exist for communications between certain common electronic produces, a need remains for effective and inexpensive communications between electronic retail systems, for example, vending machines, cash registers, kiosks, etc., and data networks for conducting electronic commerce transactions.

### SUMMARY OF THE INVENTION

The present invention provides a system and method that for electronic commerce transactions wherein an electronic retail system utilizes short-range wireless technology to establish a data connections via customers' mobile phones to authenticate and complete electronic commerce transactions.

According to one aspect of the invention, an electronic commerce system is provided. The electronic commerce system includes an electronic retail system for providing goods or services to a customer; and, a wireless communication device operable via a communications network, the device for initiating an electronic transaction with the electronic retail system, and for completing the transaction via the communications network.

According to another aspect of the invention, the both the electronic retail system and the wireless communication device have the ability to communicate with one another wirelessly.

According to another aspect of the invention, the electronic retail system is a vending machine.

According to another aspect of the invention, the communication device is a mobile phone.

According to another aspect of the invention, the communications network is the Internet.

### BRIEF DESCRIPTION OF THE DRAWINGS

Embodiments of the invention may best be understood by referring to the following description and accompanying drawings. In the description and drawings, like numerals refer to like structures and/or processes. In the drawings:

FIG. 1 is a block diagram illustrating an electronic commerce system and method in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and/or processes have not been described or shown in detail in order not to obscure the invention. In the description and drawings, like numerals refer to like structures or and/or processes.

The term Electronic Retail System (“ERS”) is used herein to refer to any electronic device that can accept payment for goods electronically. Examples are vending machines, cash registers, electronic kiosks, etc. The term Short-Range Wireless Technology (“SRWT”) is used herein to refer to technologies that permit electronic devices to communicate with other electronic devices that are nearby (usually within 100 feet). Examples of such technologies are Bluetooth, 802.11, etc. The term Long-Range Wireless Technologies (“LRWT”) is used herein to refer to technologies that permit mobile devices to communicate with telephone and data networks (Internet) at distances usually greater than 100 feet. Examples of such technologies are cellular networks such as CDMA, CDPD, TDMA, GPRS, etc. The term Subscriber Identity Modules (“SIM”) is used herein to refer to modules that can store “electronic signatures” that can uniquely identify individuals for authentication. These are useful for determining if a customer is who they claim to be for the purposes of an electronic transaction. Typically, SIMS are dime-sized pieces of hardware that can be plugged into electronic devices such as mobile phones. The term Mobile Communication Device (“MCD”) is used herein to refer to any mobile electronic device that consumers may carry with them such as mobile phones, Personal Digital Assistants (“PDAs”), laptops, and Internet appliances. These devices must have LRWT that provide the ability to communicate with carrier telecom data networks and also SRWT that will permit the MCD to communicate with ERS. The term Wireless Electronic Signal (“WES”) is used herein to refer to a wireless radio frequency signal that is used to convey electronic data from one electronic device to another. The term ERS Software (“ERSS”) is used herein to refer to software that resides on the ERS and is used to perform special functions in accordance with the present invention. The term MCD Software (“MCDS”) is used herein to refer to software that resides on the MCD and is used to perform special functions in accordance with the present invention.

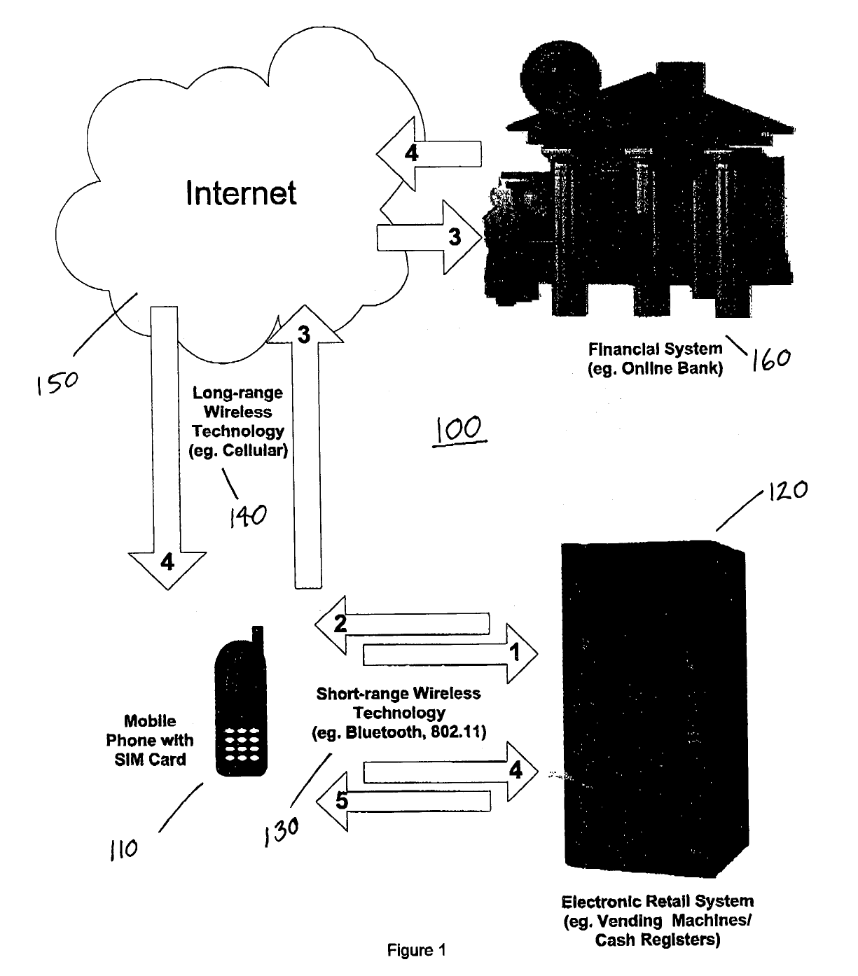

FIG. 1 is a block diagram illustrating an electronic commerce system and method in accordance with an embodiment of the invention. In FIG. 1, the electronic commerce system is shown generally by numeral 100. The system 100 includes a MCD 110, an ERS 120, SRWT 130, LRWT 140, a network (e.g. the Internet) 150, and a financial system 160. The system 100 may include an input device, a central processing unit or CPU, memory, and a display (not shown). The input device may be a keyboard, mouse, trackball, or similar device. The CPU may include dedicated coprocessors and memory devices. The memory may include RAM, ROM, databases, or disk devices. And, the display may include a computer screen or terminal device. The system 100 has stored therein data representing sequences of instructions which when executed cause the method described herein to be performed. This software includes ERSS and MCDS software. Of course, the system 100 may contain additional software and hardware a description of which is not necessary for understanding the invention.

Mobile commerce or “m-commerce” transactions utilizing personal mobile devices 110 will become one of the normal methods for payment for simple purchases such as pop from vending machines 120, hotel reservations, downloading virtual newspapers or MP3 music from electronic kiosks. The mobile device 110 is well suited to being established as the centrepiece of all m-commerce transactions in its role as the electronic wallet since most consumers will always carry one on their person.

Currently, a customer will initiate an electronic transaction by first performing a search for all available ERS 120 in their vicinity from their MCD 110. The MCD 110 will send a WES “inquiry” to all electronic devices 120. All ERS 120 will respond with WES that convey detailed information such as their name, available products and prices. The MCD 110 will display this information to the customer and the customer will select the desired product or service from the appropriate ERS 120. The MCD 110 will then send a WES to the appropriate ERS 120 indicating a customer request to perform a transaction. The ERS 120 will confirm availability of the desired product/service, calculate the cost and send an electronic “bill” to the MCD 110 for the amount of the purchase via a WES. The customer will be prompted by the MCD 110 to verify the purchase and to select the customer's account which should be used to make the purchase. The customer will provide the requested information by selecting a pre-configured account (e.g. credit, debit, etc.) for the purchase. The MCD 110 will then transmit payment account information and an authorization key (i.e. SIM chip ID or personal identification number) to the ERS 120 via a WES. The ERS 120 now has all of the required information to perform the transaction and deliver the good/service to the customer.

This sequence of steps is represented by arrows 1 and 2 in FIG. 1.

However, the ERS 120 still needs to contact a third-party payment system 160 to transfer the required funds from the customer account to the ERS account to complete the payment. Current technology requires that the ERS 120 maintain a wired or wireless data connection to a communication network 150 such as the Internet or a private network. The ERS 120 uses this data connection and the communication network 150 to transfer funds from the customer's financial account to the ERS's financial account to complete the transaction.

However, the cost of maintaining a wired or wireless data connection for the ERS 120 to conduct transactions often exceeds the cost of the ERS 120. This reduces the effectiveness of electronic commerce and makes many transactions unfeasible and unprofitable for ERS merchants. Additionally, in remote areas, it may not be possible to provide a data connection to the ERS 120 rendering such transactions impossible.

According to the present invention, a system and method is provided that allows an ERS 120 to communicate with data networks 150 to conduct electronic transactions, inexpensively and effectively.

The present invention avoids the failings of the prior art by providing an alternative method for data communication to the ERS 120. This system and method utilizes SRWT 130 and frees the ERS 120 from maintaining its own expensive wired or wireless data connection to communication networks 150 to complete financial transactions. The present invention uses SRWT 130 and the customer's MCD 110 to create a LRWT 140 data connection between the ERS 120 and the third-party financial system 160 to complete the electronic transaction. The present invention includes software that resides on the ERS 120 (i.e. ERSS) and also software that resides on the MCD 120 (i.e. MCDS). Tis software is used to make a data connection between the ERS 120 and the communication network 150.

Once the ERS 120 has all of the required financial information 1, 2 (e.g. customer financial institution, customer account, customer authorization value, etc.), the ERS 120 provides this information as input to the ERRS and invokes the ERRS.

The ERS further provides the unique device ID of the MCD 110. This will be particular to the SRWT 130 employed by the MCD 110 and ERS 120. In the case of Bluetooth technology, the ID may be Bluetooth Device Address and in the case of WiFi or 802.11 technology, the ID may be the MAC address. The ERSS uses the unique device ID of the MCD 110 and SRWT 130 to create a wireless connection with the MCD 110.

Once this SRWT 130 connection is created, the ERSS requests a LRWT data connection 140 from the MCD 120 by invoking the MCDS. The MCDS software is preconfigured by the customer (or agents of the customer) with relevant information required by the telecom carrier to create a data connection with the communication network 150 of the data carrier. This information may include APN's, gateway IP addresses, account names, account passwords, etc.

The MCDS utilizes the pre-configured information on the MCD 110 and the LRWT 140 available on the MCD 120 to create a data connection with the available data network 150. Once the connection is created, the MCDS sends a WES to the ERS 120 indicating that the data connection has been created and is available for use by the ERSS.

The ERSS utilizes the data connection provided by the MCD 110 to establish 3 a secure LRWT 140 connection to its Financial System 160 (e.g. on-line bank). This secure connection can be created using any number of encryption methods currently available that are deemed to be sufficient for commercial transactions. These methods are not described here since they are commonly available. In general, this information is encrypted so that the mobile device 110 cannot decipher it.

The ERSS, using the secure data connection provided by the MCD 120, requests a finds transfer from the Financial System 160, in the amount of the price of the good/service, from the customers account to an ERS account. The Financial System 160 performs the finds transfer and notifies 4 the ERSS that the transaction has been completed. The ERSS notifies 5 the MCDS to close the LRWT 140 data connection with the communication network 150.

As output to the ERS 120, the ERSS provides a positive feedback if the funds have transferred correctly or a negative feedback if the funds did not transfer correctly. If the ERSS has provided negative feedback, the ERS 120 sends 5 a WES to the MCD 110 indicating that there was a problem transferring the finds and the nature of the problem. The ERS 120 closes the SRWT 130 connection with the customers MCD 110 and prepares itself to process future commerce transactions.

If the ERSS has provided positive feedback, the ERS 120:

a) Sends 5 a WES to the customers MCD 110 informing the customer that the transaction has been completed successfully;

b) Provides 5 an electronic receipt to the MCD 110;

c) Delivers the product/service to the customer;

d) Closes the SRWT 130 connection with the mobile device 110; and,

e) Prepares itself to process future commerce transactions.

Data Carrier Product. The sequences of instructions which when executed cause the method described herein to be performed by the system of FIG. 1 can be contained in a data carrier product according to an embodiment of the invention. This computer software product can be loaded into and run by the system of FIG. 1.

Computer Software Product. The sequences of instructions which when executed cause the method described herein to be performed by the system of FIG. 1 can be contained in a computer software product according to an embodiment of the invention. This computer software product can be loaded into and run by the system of FIG. 1.

Integrated Circuit Produce. The sequences of instructions which when executed cause the method described herein to be performed by the system of FIG. 1 can be contained in an integrated circuit product including a coprocessor or memory according to an embodiment of the invention. This integrated circuit product can be installed in the system of FIG. 1.

Although preferred embodiments of the invention have been described herein, it will be understood by those skilled in the art that variations may be made thereto without departing from the spirit of the invention or the scope of the appended claims.

The embodiments of the invention in which an exclusive property or privilege is claimed are defined as follows:

1. An electronic commerce system comprising: an electronic retail system for providing goods or services to a customer; and, a wireless communication device operable via a communications network, said device for initiating an electronic transaction with said electronic retail system, and for completing said transaction via said communications network.

2. The system of claims 1 wherein said electronic retail system and said wireless communication device communicate with one another wirelessly.

3. The system of claim 2 wherein said electronic retail system is a vending machine.

4. The system of claim 3 wherein said communication device is a mobile phone.

5. The system of claim 4 wherein said communications network is the Internet.
